(19) United States
(12) Patent Application Publication
(10) Pub. No.: US 2024/0407601 A1
(43) Pub. Date: Dec. 12, 2024

(54) COOKING DEVICE

(71) Applicant: David Davis, Welham Green (GB)

(72) Inventor: David Davis, Welham Green (GB)

(21) Appl. No.: 18/734,402

(22) Filed: Jun. 5, 2024

(30) Foreign Application Priority Data
Jun. 6, 2023 (GB) 2308412.2

(51) Int. Cl. A47J 37/07

(52) U.S. Cl. CPC A47J 37/0718; A47J 37/0786

(57) ABSTRACT

A cooking device comprising a trough assembly and a chimney. The trough assembly comprises three or more troughs each extending radially outwards from the central section, each of the three or more troughs being configured to receive and retain combustible material from the central section. The chimney is configured to receive combustible material, the chimney fitting at least partially within the central section.

### CROSS REFERENCE TO RELATED APPLICATIONS

This application claims priority to GB Application No. GB 2308412.2, filed on 6 Jun. 2023 entitled “Cooking Device”. The disclosure of this application is hereby incorporated by reference in its entirety.

### TECHNICAL FIELD

This disclosure relates to a cooking device, and more specifically to a device that is suitable for barbecue style cooking using a combustible material, such as charcoal.

### BACKGROUND

Barbecue (BBQ) style cooking is extremely popular, and results in distinctive texture and flavour to the food cooked in this way. Typically, a BBQ involves burning of a combustible material (for example charcoal) over which food is suspended in order to allow for the burning material to cook the food. This style of cooking often results in flavour from the combustible material being incorporated into the cooked food. This effect can be further enhanced by introducing smoke-producing material, such as wood chips, into the combustible material. This can result in more pronounced “smoky” flavours being introduced into the cooked food.

However, different people have different preferences as to how they like their food to be cooked using a BBQ. For example, users may prefer to use different cooking temperatures, particularly if they are cooking different types of food. Furthermore, users may have different preferences as to the amount (if any) of smoky flavour they prefer in their food. With a typical BBQ it can be difficult, if not impossible, to simultaneously cook different food items using different cooking conditions, since a regular BBQ typically has a single combined cooking area. Cooking with different cooking temperatures can sometimes be achieved by using different regions of a grill suspended over the combustible material, however it is particularly challenging to incorporate different amounts of smoky flavouring according to preference. Typically, the only option to allow for such a variation in cooking conditions is to cook items at different times, rather than simultaneously. For example, to allow for varying smoke content, the user may have to cook food items without the additional smoke-producing material first, then add the smoke-producing material prior to cooking subsequent items. However, this has the drawback that the different food items are not prepared simultaneously, reducing the enjoyment of users wishing to eat the items at the same time.

A further drawback with existing BBQ type cooking devices is the inability to refuel such devices with additional combustible material while simultaneously allowing for food to be cooked. Most BBQ style cooking devices use solid fuel such as charcoal, which must be ignited and allowed to burn for a period of time before it is suitable for use in cooking food. This is because when first ignited, the charcoal can give off excessive smoke which can spoil the flavour of the food, and also tends to burn with a large flame that is unsuitable for cooking. With typical BBQ style cooking devices, once the combustible fuel is depleted, cooking must be paused while additional fuel is added and allowed to burn down to a suitable cooking condition.

There exists, therefore, a need to produce an improved cooking device for the cooking of BBQ style food.

### SUMMARY OF THE INVENTION

According to a first aspect of the present disclosure, there is provided cooking device comprising: a trough assembly comprising a central section and three or more troughs each extending radially outwards from the central section, each of the three or more troughs being configured to receive and retain combustible material from the central section; and a chimney for receiving combustible material, the chimney fitting at least partially within the central section.

In an embodiment, there is provided a cooking device further comprising an upper plate, the upper plate having one or more openings, the openings extending over each of the central section and the respective three or more troughs.

In an embodiment, there is provided a cooking device further comprising one or more first cooking support members, wherein each of the first cooking support members is arranged proximate to one of the three or more troughs, and is configured to support a cooking implement.

In an embodiment, there is provided a cooking device wherein each of the one or more first cooking support members is arranged at a radially outward end one of the three or more troughs.

In an embodiment, there is provided a cooking device wherein each of the one or more first cooking support members is attached or attachable to the trough assembly or an upper plate.

In an embodiment, there is provided a cooking device further comprising one or more second cooking support members, wherein each of the second cooking support members is arranged proximate to one of the three or more troughs, and is configured to support a cooking implement.

In an embodiment, there is provided a cooking device wherein each of the one or more second cooking support members is arranged proximate to the radially inward end of the cooking trough.

In an embodiment, there is provided a cooking device wherein each of the one or more second cooking support members is arranged substantially opposite a first cooking support member.

In an embodiment, there is provided a cooking device wherein each of the one or more 20 second cooking support members is attached or attachable to the chimney.

In an embodiment, there is provided a cooking device wherein each of the one or more troughs comprise an opening configured to facilitate entry of air into the respective trough to, in use, aid with combustion of combustible material retained within the trough.

In an embodiment, there is provided a cooking device wherein the chimney and the central opening are configured to allow the chimney to be removably insertable into the central opening.

In an embodiment, there is provided a cooking device wherein the chimney and the central opening are configured such that when the chimney is fully inserted into the central opening, the chimney partially covers the openings between each of the three or more troughs and the central section.

In an embodiment, there is provided a cooking device wherein the chimney and the central opening are configured such that when the chimney is fully inserted into the central opening, the distance between the bottom of the chimney and the bottom of the trough assembly is equal to or greater than the distance between the bottom of the chimney and the top of the trough assembly.

In an embodiment, there is provided a cooking device further comprising a base plate attached or attachable to the trough assembly.

In an embodiment, there is provided a cooking device further comprising one or more legs configured to support the cooking device.

### BRIEF DESCRIPTION OF THE DRAWINGS

One or more embodiments of the present disclosure will now be described by way of example only, with reference to the accompanying drawings, in which:

FIG. 1 illustrates an example of a BBQ style cooking device, according to the present disclosure;

FIG. 2 illustrates the BBQ style cooking device of FIG. 1, where the components have been separated to show individual features of the components;

FIG. 3 illustrates a top-down view of an example trough assembly, according to the present disclosure; and

FIG. 4 illustrates an example of a fire poker which may be used to manipulate combustible material within the cooking device.

### DETAILED DESCRIPTION

According to the present disclosure, there is provided a cooking device configured allow for the simultaneous cooking of multiple different items of food using separate and isolated cooking environments. This may allow different food items to be cooked under different conditions simultaneously, for example with differing cooking temperatures. This may also allow for different items to be cooked using differing amounts/quantities of additional smoke-producing material (such as wood chips).

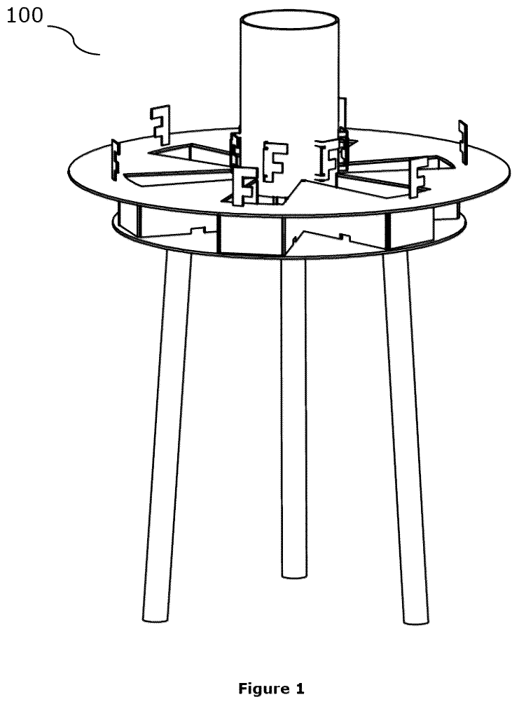

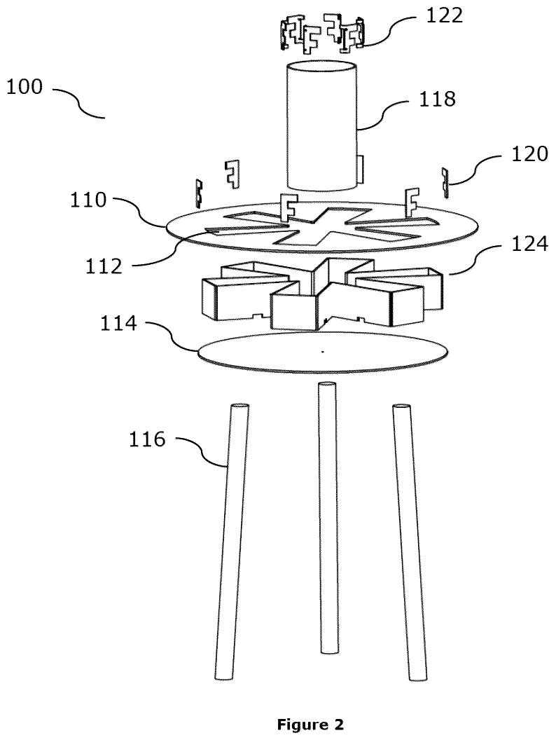

FIG. 1 illustrates an example of a cooking device 100 according to the present disclosure. The cooking device 100 illustrated in FIG. 1 is also illustrated in FIG. 2, but in FIG. 2 the illustrated components have been separated in order to allow for each component to be more easily seen.

A cooking device 100 according to the present disclosure comprises a trough assembly 124, the trough assembly 124 comprising a central section 102 and three or more troughs 104 extending radially outwards from the central section 102.

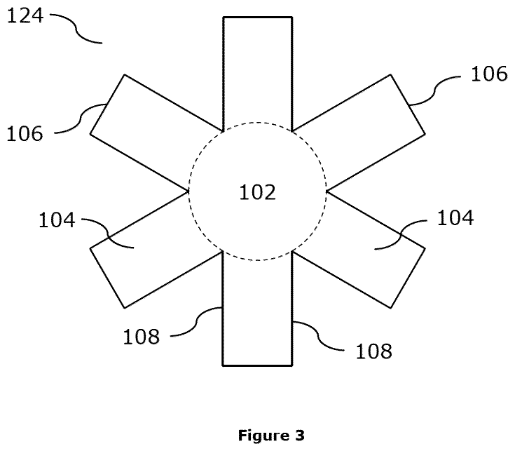

FIG. 3 illustrates an example of a trough assembly 124 viewed from the top down. The dashed line in FIG. 3 denotes the boundary between the central section 102 and each of the troughs 104. In some examples, there may be no physical boundary between the central section 102 and the troughs 104. In some examples, there may be a boundary that extends at least partially between the central section 102 and the troughs 104, however in all examples the trough assembly 124 is configured such that, in use, combustible material can be moved by a user from the central section 102 into at least one of the troughs 104. In the illustrated example, the trough assembly 124 comprises six troughs 104 arranged around a central section 102. In other examples, the trough assembly 124 may comprise other numbers of troughs may be used (providing there are at least three troughs 104) and the troughs 104 and central section 102 may be arranged in any suitable manner.

Each of the troughs 104 is configured to receive and retain combustible material. In use, the combustible material may be drawn from the central section 102 into any of the troughs 104 by any suitable means. In use, the combustible material in the central section 102 is ignited prior to being drawn into the one or more troughs 104 by a user. In some examples, in use, the combustible material may be ignited and allowed to burn for a predetermined amount of time such that it is ready for use in providing heat for cooking, prior to being drawn into one or more of the troughs 104.

In use, the user is able to draw a suitable amount of ignited combustible material from the central section 102 of the trough assembly 124 into a trough 104 to provide the user's preferred cooking conditions. In some examples, when a user desires higher cooking temperatures they may draw more of the ignited combustible materials into one of the troughs 104. In some examples, when a user desires lower cooking temperatures they may draw less of the ignited combustible materials into one of the one or more troughs 104. In some examples, in use, when the user has finished cooking they may push any remaining combustible materials back into the central section 102.

In some examples, in use, after drawing combustible materials into a trough 104 the user may add smoke-producing material (such as wood chips) to the combustible material retained within the trough 104 in order to provide their preferred cooking conditions.

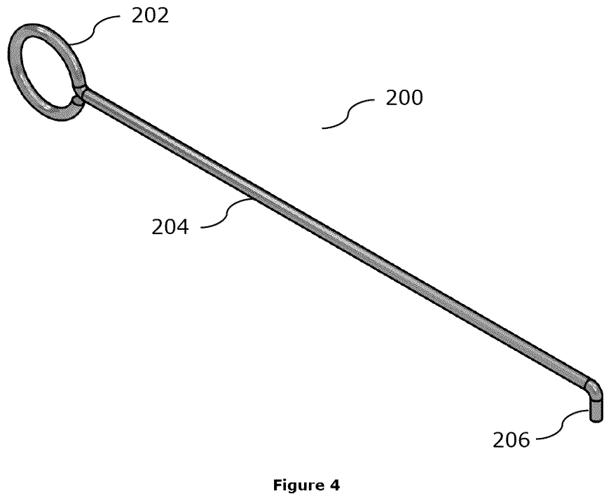

In some examples, a user may be provided with a device for drawing the combustible materials from the central section 102 into a trough 104, such as a rake. FIG. 4 illustrates an example of such a device 200, which may in some examples be referred to as a “rake” or a “fire poker”. The illustrated fire poker 200 comprises a handle 202, a body 204 and a rake portion 206. In some examples, the fire poker 200 may be formed from a single piece of material, with one end formed into a handle 202 and the other end into a rake portion 206, with a body 204 portion extending between the handle 202 and the rake portion 206. In some examples, the fire poke 200 may be formed from a single piece of any suitable material, such as steel.

In the illustrated examples, each of the troughs 104 comprises two side walls 108 extending radially outwards from the central section 102, and an end wall 106 at the radially outward end of the trough 104. The two side walls 108 and the end wall 106 define the outer perimeter (when viewed from above) of the trough 104, with the remaining side being occupied by the central section 102, this remaining side being left at least partially open in order to allow for combustible material to be drawn from the central section 102 into the trough 104, in use.

In some examples, the end wall 106 may abut, be attached or be attachable to one or both of the side walls 106. Attachment may be substantially permanent (for example, by welding or by forming from a continuous piece) or may be removable (for example by bolting, or by an interference fit). In some examples, the end wall 106 and at least one of the side walls 108 may be formed from one continuous piece of material.

In some examples, the side walls 108 may not extend all the way out to the outer perimeter of the trough assembly 124. In some examples, the troughs 104 may not comprise an end wall 106. In some examples, the troughs 104 may have a substantially different shape to those illustrated in the figures.

In some examples, each of the troughs 104 comprises a bottom that extends between the side walls and the end wall and is arranged to substantially support the combustible material when it is drawn into the troughs 104. In some examples, the bottom may be formed continuously with any/all of the side walls 108 and the end wall 106. In some examples, the bottom may abut, be attached or be attachable to any or all of the side walls 108 and the end wall 108. Attachment may be substantially permanent (for example, by welding or by forming from a continuous piece) or may be removable (for example by bolting, or by an interference fit).

In some examples, the central section 102 comprises a bottom that extends substantially across the whole of the lower extremity of the central section 102. In such examples, the bottom is arranged to substantially support the combustible material retained within the central section 102, in use. In such examples, the bottom of the central section 102 may abut, be attached to, be attachable to or be continuous with the bottom of one or more of the troughs 104. Attachment may be substantially permanent (for example, by welding or by forming from a continuous piece) or may be removable (for example by bolting, or by an interference fit).

The side walls 108 and the end wall 106 of each of the troughs 104 may be formed of any suitable material. In some examples, steel may be used. Steel is advantageous as it is strong, cheap, tough, durable, easy to machine, easy to bond and has suitable thermal and corrosion resistance properties. Furthermore, steel components can be easily attached to each other by various means, including by welding. In some examples, 6 mm thick steel plate may be used.

In the illustrated examples, the trough assembly 124 comprises six troughs 104 each with a roughly rectangular shape (when viewed from above) each extending outwards from the central section 102. In other examples, any number of troughs 104 may be included in the trough assembly 124 providing at least three troughs 104 are present. Each of the troughs 104 may be of any shape, size, and dimensions.

In some examples, each of the troughs 104 may be of equal size and shape to each other trough 104. This may be advantageous as it may simplify the manufacturing process. In other examples, one or more troughs 104 may have different dimensions to other troughs 104. This may be advantageous as it may allow for different cooking environments to be provided by different troughs 104. For example, a larger trough 104 may be suitable for cooking a larger item of food.

In some examples, a trough 104 may comprise one or more holes located in one of the components defining the perimeter of the trough 104 (e.g., the side walls 108 and/or the end wall 106), the one or more holes being configured to allow additional air to enter the trough 104 thereby to improve the combustion conditions for the combustible material. In some examples, the one or more holes may be located substantially towards the bottom of the trough side walls 108 and/or end walls 106. The hole being located on the side wall 108 and/or end wall 106 may be beneficial because these components are less important than the bottom of the trough 104 for retaining the combustible material, in use. In some examples, the one or more holes may be located only on the side wall(s) 108, this may be beneficial as it may be less likely that, in use, combustible material falling through such a hole would fall on a user.

In some examples, the one or more holes may be located substantially towards the bottom of the troughs 104 (even when disposed on the side wall(s) 108 and/or the end wall 106). This may be advantageous as convection currents caused by the hot combustible material may help to draw air in to the trough 104 through the holes.

The cooking device 100 comprises a chimney 118. The chimney 118 may be substantially elongated in one direction, with an upper opening and a lower opening. In some examples, including the example illustrated in FIGS. 1 and 2, the chimney 118 is substantially cylindrical in shape, however any other suitable shape may be used. The chimney 118 may comprise any suitable material, for example steel.

The chimney 118 is configured to received and at least partially retain combustible material. The chimney 118 is further configured such that, in use, smoke and combustion gasses (such as carbon dioxide) are drawn upwards and out of the upper opening of the chimney 118 due to thermally driven convection currents. In use, the combustible material received by the chimney 118 may be ignited prior to being introduced to the chimney 118, or may be ignited after being introduced to the chimney 118. In some examples, in use, combustible material may be introduced into the chimney 118 though an opening on one side of the chimney 118. In some examples, the combustible material may be introduced through the upper opening of the chimney 118. In such examples, in use, the combustion material is introduced through the same opening that is configured to direct and exhaust the smoke and other combustion gasses.

The chimney 118 is configured to be at least partially inserted in to the central section 102 of the trough assembly 124. In use, the chimney 118 is at least partially inserted into the central section 102 of the trough assembly 124 and extends upwards out of the central section 124. In some examples, the chimney 118 is configured such that when combustible material retained within the chimney 118 is ignited, the chimney 118 causes sufficient convectional movement of air to draw smoke and other combustion gases upwards and out of an upper opening, while drawing colder air (comprising oxygen) into the bottom of the chimney 118. The convection current caused by the chimney 118, in use, may facilitate and enhance further combustion of the combustible material.

In some examples, in use, the combustible material received and at least partially retained by the chimney 118 drops from the bottom of the chimney 118 into the central section 102 of the trough assembly 124. In such examples, after dropping from the bottom of the chimney 118 the combustible material is substantially retained within the central section 102 of the trough assembly 124. In some examples, the combustion material is ignited and at least partially combusted before it drops from the bottom of the chimney 118 into the central section 102 of the trough assembly 124.

In some examples, in use, the chimney 118 can receive additional combustible material, while previously added combustible material is already being burned within the cooking device. This allows for the cooking device to be refueled, while the device is in use. In some examples, additional unburned combustible material can be introduced to the cooking device and ignited, while combustible material that has already been at least partially burned is being used to cook food. In some examples, this may allow for the additional combustible material to be ignited and allowed to burn down while being isolated from the cooking region (for example, the troughs 104). This may be particularly advantageous when solid combustible material, such as charcoal, is used. Such a combustible material typically needs to be burned for at least a pre-determined amount of time before it is suitable for use in providing heat for cooking. When the combustible material has burned down sufficiently to be suitable for use in cooking, the user can draw the burned down combustible material into one or more of the troughs for use in cooking. In some examples, such an arrangement may allow for food to be cooked continuously using a combustible material such as charcoal, without requiring users to stop cooking food in order for the cooking device to be refueled.

In some examples, when the chimney 118 is fully inserted into the central section 102 of the trough assembly 124, a gap remains between the bottom of the chimney and the bottom of the trough assembly 124. In use, this may allow for combustible material retained within the central section 102 and below the bottom of the chimney 118, to be drawn into one or more of the troughs 104 by a user.

In some examples, when the chimney 118 is fully inserted into the central section 102, the distance between the bottom of the chimney 118 and the bottom of the trough assembly 124 is larger than the distance between the bottom of the chimney 118 and the top of the trough assembly 124.

In the example illustrated in FIG. 1, each of the troughs 104 is approximately 100 mm deep (when measure from the top to the bottom of a side wall 108 of the trough 104). In this example, when the chimney 118 fully inserted into the central section 102, the distance from the bottom of the chimney 118 to the bottom of the trough assembly 124 is approximately 70 mm, while the distance from the bottom of the chimney 118 to the top of the trough assembly 124 is approximately 30 mm.

In some examples, the chimney 118 may be configured to be removably insertable into the central section 102 of the trough assembly 124. This may allow for the chimney 118 to be removed from the central section 102 when the cooking device 100 is not in use. This may be advantageous as it may allow for the cooking device 100 to be more easily stored and/or transported.

In some examples, the cooking device 100 further comprises an upper plate 110. As shown in FIGS. 1 and 2, in use the upper plate 110 is located above the trough assembly 124. The upper plate comprises one or more openings, the openings being arranged to substantially extend over each of the troughs 104 and the central section 102 of the trough assembly 124. The opening extending over the central section 102 is configured to allow for the chimney 102 to pass though the opening, so as to be at least partially inserted within the central section 102 of the trough assembly. In some examples, in use, the upper plate 110 may be at least partially in contact with the chimney 118. In some examples, the upper plate 110 may abut, be attached to or be attachable to at least part of the chimney 118. Attachment may be substantially permanent (for example, by welding or by forming from a continuous piece) or may be removable (for example by bolting, or by an interference fit).

As illustrated in FIGS. 1 and 2, the upper plate 110 may comprise a single opening configured to extend substantially over each of the troughs 104 and the central section 102 of the trough assembly 124. In some examples, the upper plate 110 may comprise more than one opening.

As illustrated, the upper plate 110 may be configured to substantially cover the areas between each of the troughs 104 of the trough assembly 124. In some examples, the upper plate may be configured to extend radially outwards beyond each of the troughs 104 of the trough assembly 124. In such examples, the upper plate 110 may be configured to have a substantially continuous outer perimeter, such that the upper plate extends radially outwards beyond each of the outer ends of the opening(s).

The upper plate 110 may comprise any suitable material. In some examples, the upper plate 110 may comprise steel. Steel is advantageous as it is strong, cheap, tough, durable, easy to machine, easy to bond and has suitable thermal and corrosion resistance properties.

In some examples, the upper plate 110 may be configured to abut at least part of the trough assembly 124. In some examples, the upper plate 110 may be attached or attachable to at least part of the trough assembly 124. In examples where the upper plate 110 is attached to the trough assembly 124, the attachment may be substantially permanent (for example, by welding or by forming from a continuous piece) or may be removable (for example by bolting, or by an interference fit). Substantially permanent attachment may be beneficial for providing improved structural strength to the cooking device 100. Removable attachment may be advantageous as it may allow for the cooking device 100 to be more easily stored and/or transported.

In some examples, the cooking device 100 may further comprise one or more first cooking support members 120. Each first cooking support member 120 is configured to support a cooking implement arranged proximate to one of the troughs 104. A cooking implement may be, for example, a skewer. In some examples, the cooking support member 120 may be configured to secure the cooking implement over one of the troughs 104. In use, this may facilitate cooking of food retained by the cooking implement by holding it over combustible material retained within the trough 104.

In some examples, the first support members 120 may be configured so as to provide support for multiple cooking implements. In some examples, the first cooking support members 120 may be configured to allow for cooking implements to be retained in different ways, so as to provide different cooking options. For example, a first cooking support member 120 may facilitate locating a cooking implement at several different heights over a trough 104, thereby to allow for different levels of heat to be applied to the food retained by the cooking implement.

In some examples, the cooking device 100 may comprise multiple first cooking support members 120 which may be substantially alike or may be different to each other.

In some examples, each of the first cooking support members 120 are located proximate to a trough 104. In some examples, each of the first cooking support members 120 is located radially outwards of the outer end of a trough. In other examples, one or more first cooking support members 120 may be located to the side of any of the troughs 104.

In examples where the cooking device 100 comprises an upper plate 110, the first cooking support members 120 may be attached or be attachable to the upper plate 110. In examples where the cooking support members 120 are attached to the upper plate 110, the attachment may be substantially permanent (for example, by welding or by forming from a continuous piece) or may be removable (for example by bolting, or by an interference fit).

In examples where the cooking device 100 does not comprise an upper plate 110, the first cooking support members 120 may be attached or attachable to the trough assembly 124. In examples where the first cooking support members 120 are attached to the trough assembly 124, the attachment may be substantially permanent (for example, by welding or by forming from a continuous piece) or may be removable (for example by bolting, or by an interference fit).

In some examples, the cooking device may comprise one or more second cooking support members 122. The second cooking support members 122 are substantially the same as the first cooking support members 120 described above but, in use, are located radially inwards of the troughs 104, rather than radially outwards or to the side of the troughs as is the case for the first cooking support members 120.

In some examples, a second cooking support member 122 may be located substantially opposite to a first cooking support member 120 such that, in use, a cooking implement may be supported by both cooking support members simultaneously. This may be advantageous in securely supporting the cooking implement, in use.

In some examples, the second cooking support members 122 may be attached or attachable to the chimney 118. In examples where the second cooking support members 122 are attached to the chimney 118, the attachment may be substantially permanent (for example, by welding or by forming from a continuous piece) or may be removable (for example by bolting, or by an interference fit).

The first cooking support members 120 and second cooking support member 122 may comprise any suitable material, for examples steel.

In some examples, the cooking device 100 may further comprise a base plate 114. In such examples, in use, the base plate 114 is located below the trough assembly 124. In some examples where the cooking device 100 comprises a base plate 114, the base plate 114 may, in use, also function as the bottom of the trough assembly 124. In such examples, the trough assembly comprises only side walls 108 and, optionally, end walls 106; the trough assembly 124 would not also comprise a bottom. In such examples, in use, at least part of the trough assembly is in contact with the base plate 114, the base plate 114 extending at least across the whole area of the trough assembly 124 and thereby providing a bottom for the trough assembly 124.

In some examples, the base plate 114 may be attached or attachable to at least part of the trough assembly 124. In examples where the upper plate 110 is attached to the trough assembly 124, the attachment may be substantially permanent (for example, by welding or by forming from a continuous piece) or may be removable (for example by bolting, or by an interference fit). Substantially permanent attachment may be beneficial for providing improved structural strength to the cooking device 100. Removable attachment may be advantageous as it may allow for the cooking device 100 to be more easily stored and/or transported.

The base plate 114 may comprise any suitable material, for example steel.

In some examples, the cooking device 100 may further comprise one or more legs 116. The one or more legs 116 may be configured to support the cooking device 100 and to raise it to a suitable height above the ground, to facilitate use. The one or more legs 116 may comprise any suitable material, for example steel.

In examples where the cooking device 100 comprises a base plate 114, the one or more legs 116 may be attached or attachable to the base plate 114. In examples where the cooking device does not comprise a base plate 114, the one or more legs 116 may be attached or attachable to the trough assembly 124.

The attachment of the one or more legs 116 to the base plate 114 and/or the trough assembly 124 may be substantially permanent (for example, by welding or by forming from a continuous piece) or may be removable (for example by bolting, or by an interference fit). Substantially permanent attachment may be beneficial for providing improved structural strength to the cooking device 100. Removable attachment may be advantageous as it may allow for the cooking device 100 to be more easily stored and/or transported.

A number of embodiments have been described. Nevertheless, it will be understood that various modifications can be made. Accordingly, other embodiments are within the scope of the following claims. Within the scope of this application it is expressly intended that the various aspects, embodiments, examples and alternatives set out in the preceding paragraphs, and the claims and/or the following description and drawings, and in particular the individual features thereof, may be taken independently or in any combination. That is, all embodiments and all features of any embodiment can be combined in any way and/or combination, unless such features are incompatible. The applicant reserves the right to change any originally filed claim or file any new claim accordingly, including the right to amend any originally filed claim to depend from and/or incorporate any feature of any other claim although not originally claimed in that manner.

1. A cooking device comprising:
a trough assembly comprising a central section and three or more troughs each extending radially outwards from the central section, each of the three or more troughs being configured to receive and retain combustible material from the central section; and
a chimney for receiving combustible material, the chimney fitting at least partially within the central section.

2. A cooking device according to claim 1, further comprising an upper plate, the upper plate having one or more openings, the openings extending over each of the central section and the respective three or more troughs.

3. A cooking device according to claim 1, further comprising one or more first cooking support members, wherein each of the first cooking support members is arranged proximate to one of the three or more troughs, and is configured to support a cooking implement.

4. A cooking device according to claim 3, wherein each of the one or more first cooking support members is arranged at a radially outward end one of the three or more troughs.

5. A cooking device according to claim 3, wherein each of the one or more first cooking support members is attached or attachable to the trough assembly or an upper plate.

6. A cooking device according to claim 1, further comprising one or more second cooking support members, wherein each of the second cooking support members is arranged proximate to one of the three or more troughs, and is configured to support a cooking implement.

7. A cooking device according to claim 6, wherein each of the one or more second cooking support members is arranged proximate to the radially inward end of the cooking trough.

8. A cooking device according to claim 6, wherein each of the one or more second cooking support members is arranged substantially opposite a first cooking support member.

9. A cooking device according to any of claim 6, wherein each of the one or more second cooking support members is attached or attachable to the chimney.

10. A cooking device according to claim 1, wherein each of the one or more troughs comprise an opening configured to facilitate entry of air into the respective trough to, in use, aid with combustion of combustible material retained within the trough.

11. A cooking device according to claim 1, wherein the chimney and the central opening are configured to allow the chimney to be removably insertable into the central opening.

12. A cooking device according to claim 1, wherein the chimney and the central opening are configured such that when the chimney is fully inserted into the central opening, the chimney partially covers the openings between each of the three or more troughs and the central section.

13. A cooking device according to claim 12, wherein the chimney and the central opening are configured such that when the chimney is fully inserted into the central opening, the distance between the bottom of the chimney and the bottom of the trough assembly is equal to or greater than the distance between the bottom of the chimney and the top of the trough assembly.

14. A cooking device according to claim 1, further comprising a base plate attached or attachable to the trough assembly.

15. A cooking device according to claim 1, further comprising one or more legs configured to support the cooking device.
